(19) United States
(12) Patent Application Publication
(10) Pub. No.: US 2008/0179350 A1
(43) Pub. Date: Jul. 31, 2008

(54) Adapter For a Selective Inverted Actuation of Pump Dispensers

(76) Inventors: Reinhard Neuhaus, Hemer (DE); Detlef Schmitz, Lunen (DE); Bernhard Jasper, Waltrop (DE); Ralf Jordan, Dortmund (DE)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/664,638

(22) PCT Filed: May 25, 2005
(86) PCT No.: PCT/EP05/05677

§ 371 Date: Nov. 6, 2007

(30) Foreign Application Priority Data
Oct. 4, 2004 (DE) 10 2004 048 248.9

(51) Int. Cl. B65D 88/54; B67D 5/40

(52) U.S. Cl. 222/321.4; 222/376

(57) ABSTRACT

The invention relates to a dispenser (10) comprising a pump housing (14) with an adapter (12) for a container that contains fluid. Said dispenser comprises an adapter housing (24) with a passage (20) and inlets (28) for the fluid, an inlet valve (30) that is located in an annular chamber (51) and a non-return valve (32) that is located in a valve chamber (34). The adapter housing (24) consists of an upper part (44) and a lower part (46), which form the annular chamber (51), that latter being centrally traversed by a connecting pipe (52). A base (50) of the annular chamber (51) contains fluid inlets (28) for the inverted position of the dispenser (10) and comprises a fluid-tight collar (60) that projects radially beyond the inlets (28). The inlet valve (30) is an annular, flexible elastic valve disc (31), which surrounds and seals the annular groove (58) and whose external edge lies on the fluid-tight collar (60), sealing the inlets (28). In the inverted position of the adapter (12) however, the inlet valve is lifted off the fluid-tight collar (60) in order to open the inlets (28). The dispenser (10) permits an operationally reliable actuation in the normal upright position and in the inverted position. It has a simple construction and is thus economical to produce.

The invention relates to a manually operated dispenser with adapter for a fluid that is, or can be pressurized in a container, in its substantially upright position, and in its substantially inverted or overhead position according to the pre characterizing part of Patent claim 1.

Dispensers formed as manually operated pumps for containers for liquids or for dispensing valves for liquid containers pressurized by a propellant gas are known, having an associated auxiliary valve for taking in liquid from a container, which is in a slanted or substantially inverted or overhead position. The auxiliary valve in these known devices comprises a ball valve, which is associated with the pump housing or valve housing of the respective dispenser. The ball valve is supported parallel to the axis of the associated container between an open position and a closed position in a valve chamber in a manner that it is freely moveable back and forth. It is only subject to gravity, so that the ball valve, depending on the inclination of the container, and on the viscosity of the fluid in the container, reaches its final position more or less quickly, or not at all. This leads among other things to an uneven dispensing of the liquid in the container due to variable air mixing and is perceived as detrimental by the consumer. This disadvantage comes to bear in particular with cosmetic or pharmaceutical products, wherein the consumer relies on the dispensing of a certain volume of product when operating such dispensing packages.

In the European Patent application 01 951 540.2, an adapter was already proposed for these reasons, which can be used optionally in combination with typical manually operated pumps or dispensing valves on containers pressurized by propellant gas, and which additionally provides dispensing of a constant amount of fluid in each position of a container deviating from the normal upright position, as e.g. an inverted or slanted position of the container. Each dispenser designed only for an operation and functionality in the upright position of the container shall be useable through the utilization of this known adapter also for an operation and dispensing of the fluid in the container in an inverted or overhead position of the container. For this said purpose, the adapter housing has a connection channel between the riser tube and the pass-through channel of the housing of the dispenser, which has inlets for the fluid in an inverted position. An inlet valve within the adapter housing is provided shaped as a sleeve and closes the inlets in the upright position of the container, while freeing the inlets in the inverted position of the container.

It is the object of the invention to simplify this known dispensing device, and to make it function reliably in the normal upright position, and also in the inverted position of the container fitted with the dispenser, and more economical to produce.

The invention accomplishes this objective through the features included in Patent claim 1.

Advantageous refinements of the invention are included in the dependent claims.

Through the adapter according to the invention, it is accomplished that each dispenser created for dispensing fluid in the normal upright position of a container can be converted to and used as a very economical and universally useable dispenser, which dispenses a constant amount of fluid in any position of the container through joining the adapter to the lower end of the housing of the respective dispenser

The invention is subsequently described in more detail with reference to the schematic drawing of several embodiments. It is shown in:

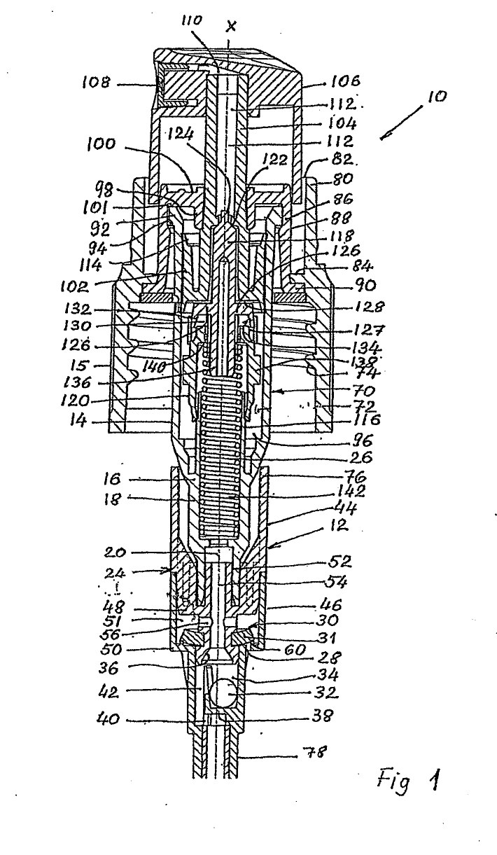

FIG. 1 a dispenser with adapter according to the invention in connection with a hand operated pump in a central longitudinal sectional view;

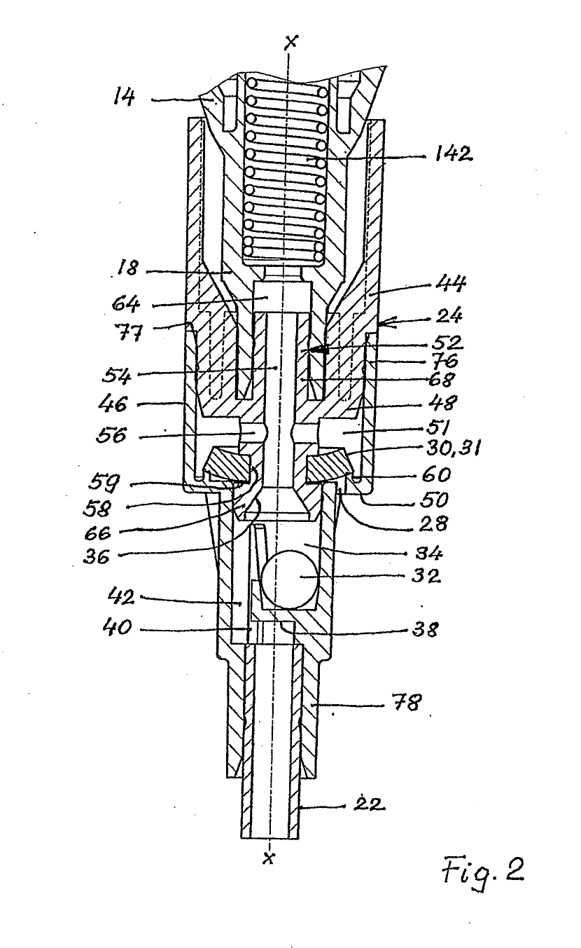

FIG. 2 the adapter in connection with the hand pump in an enlarged cutout of FIG. 1 with a closed inlet valve in an upright position of the dispenser; and

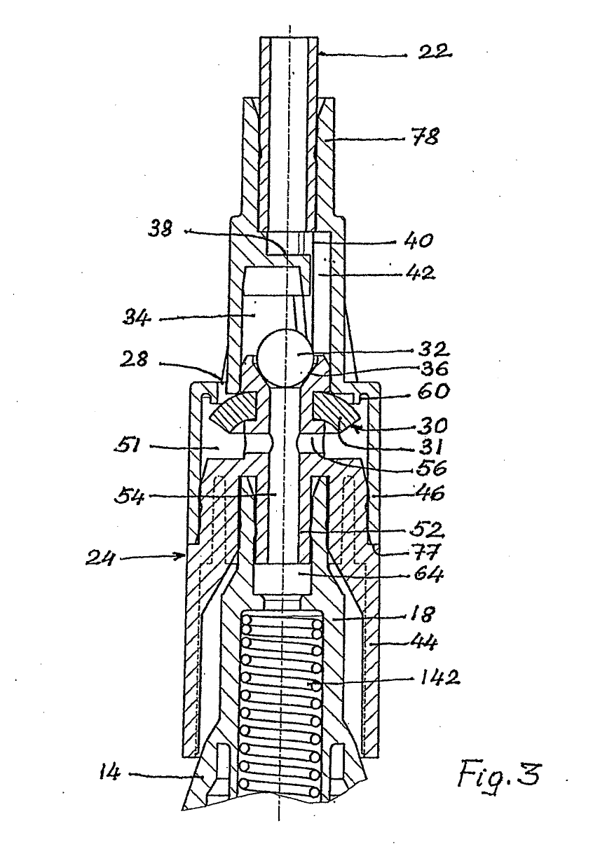

FIG. 3 the adapter in connection with the hand pump in an enlarged cutout of FIG. 1 with an open inlet valve according to an inverted position of the dispenser.

In FIGS. 1 and 2 a hand operated dispenser 10 is shown with an adapter 12 for a fluid that is pressurized, or can be pressurized in a container not shown in the Figures, in an approximately upright position and in FIG. 3 in an inverted position.

A pump housing 14 can be mounted tight on an opening of a container with a neck with an outside thread, with a threaded cap 15, and has a housing floor 16, at whose lower end a connection nipple 18 is located.

A passage 20 extends from a pump chamber 96 of the pump housing 14 through the housing floor 16 and the connection nipple 18 and is connected in the substantially vertical position of the container with a riser tube 22 reaching into the fluid in the container in order to allow the pass-through of the fluid.

A tubular adapter housing 24 includes a connection channel 54 coaxial to the main axis X-X of the dispenser 10 between the riser tube 22 and the passage 20 of the pump housing 14 of the dispenser 10.

Furthermore, several inlets 28 are provided in the adapter housing 24 for the fluid in an inverted position of the container leading towards the dispenser 10.

An inlet valve 30 is provided as a flexible elastic annular valve disk 31, which is located within the adapter housing 24 for the approximately simultaneous closure of the inlets 28 in the substantially vertical position of the container, but which is located for the simultaneous opening of the inlets 28 with a pressure impacting upon the fluid in the container in the substantially inverted position of the container.

A spherical stop valve 32 is located within a stop valve chamber 34 of the adapter housing 24 between two end positions so it can move freely in axial direction. In a vertical position of the dispenser 10, according to FIGS. 1 and 2, the upper end position is defined through a conical stop valve seat 36 extending laterally through the adapter housing 24, and the lower position is defined by a support device 38, in which the stop valve assumes a throttle position for the fluid leaving a throttle opening 40. The stop valve chamber 34 has a diameter, which is larger than the diameter of the stop valve 32, in order to form a bypass flow channel 42 for the fluid in a vertical position of the container.

The adapter housing 24 comprises an upper piece 44 and a lower piece 46, whose floors 48 and 50 are located at an axial distance from another. The connecting channel 54 is provided as an annular chamber 51 between these floors 48, 50, through which a tubular spout 52 of the upper piece 44 reaches in a coaxial manner.

The tubular spout 52 includes the connection channel 54, which establishes a fluid connection between the stop valve chamber 34 and the pump housing 14. Furthermore, the tubular spout 52 within the annular chamber 51 directly under the floor 48 of the upper piece 44 is provided with an annular groove 58, in whose floor lateral bore holes 56 are provided, connecting the annular chamber 51 with the connection channel 54 and the passage 20 (FIGS. 1, 2, and 3). The annular groove 58 has an approximately rectangular cross section, wherein a lower surface 59 of the annular groove 58 is approximately flush with the upper side of the bottom 50 of the lower piece 48. If applicable, the cross section of the annular groove 58 can also be arched.

The bottom 50 of the lower piece 48 of the adapter housing 24 includes the inlets 28 for the fluid in an inverted position of the adapter 12 (FIG. 3), wherein the inlets 28 are preferably located at identical circumference angle offsets from each other.

Furthermore, the upper side of the floor 50 within the annular chamber 51 has a fluid tight collar 60, which protrudes radially outside of the inlets 28 from the floor 50 of the annular groove 58. The height of the fluid tight collar 60 is a fraction of the axial height of the annular groove 58, e.g. ⅕ of it, and largely depends on the bending elasticity of the valve disk 31 and the pump pressure.

The inlet valve 30 is a common annular valve disk 31, elastic in bending direction, which is made from silicone or PE. The valve disk 31 encloses the annular groove 58 tight with a preload and rests in resting position with the lower side of its outer rim on the fluid tight collar 60, sealing the inlets 28 and rises from the fluid tight collar 60 with its outer rim in the inverted position of the adapter 12 according to FIG. 3, even under low suction of the pump for opening the inlets 28.

The upper piece 44 of the adapter housing 24 is placed onto the lower end of the pump housing 14 and onto its connection nipple 18 in a friction locked manner. Thereby, the tubular spout 52 protrudes from the bottom 48 of the upper piece 44, and is inserted into an opening 64 of the connection nipple 18 of the pump housing 14, coaxial with the main axis X-X of the dispenser 10.

A lower longitudinal section of the tubular spout 52 (FIGS. 2 and 2) extends from the lower side of the floor 48 of the upper piece 44 through the annular chamber 51 and the annular floor 50 of the lower piece 46 into the upper end of the stop valve chamber 34, and forms the conical valve seat 36 at the lower end for the ball shaped stop valve 32 in the inverted position of the dispensing device 10 (FIG. 3).

In FIG. 1 the dispenser 10 is shown as a dosage pump 70. The pump 70 is mounted in the closing cap 72, which has suitable and known means, as e.g. a thread 74 for mounting the closing cap 72 together with the pump 70, located in it, on the neck of a common container provided with the respective outside thread.

The container is filled with a liquid product. The liquid product is sucked into the pump 70 through the connection nipple 18, which is connected with the lower side of the pump 70. The upper section 44 of the adapter 12 is mounted to the connection nipple 18 with its upper sleeve shaped end 76, while the lower piece 46 receives the upper end of the riser tube 22 in a riser tube nipple 78, which extends to the throttle opening 40, and which ends at an axial distance below the support device 38. The lower end of the riser tube 32 is therefore normally submerged into the fluid, when an associated container is disposed in a substantially vertical position. The lower section 46 reaches around the lower end of the upper piece 44 with its upper sleeve shaped end 76 and abuts to an annular stop surface 77 of the upper piece with its upper front face. The outside diameters of the lower piece 46, the upper piece 44 and the pump housing 14 are equal, so that these said parts constitute an elongated cylindrical body in the assembled state.

The closing cap 72 has a cylindrical hollow wall 80, which surrounds an opening 82, which is limited through an interior flange 84 above the thread 74. Within the opening 82 there is a holder 86, which has an outside wall 88, which forms an annular flange 90 protruding to the outside at its lower end. The annular flange 90 is fixed with respect to the upper side of the container opening and sealed. The holder 86 serves for mounting the pump 70 in the closing cap 72. For this purpose the pump housing 14 is provided with an outer flange at its upper end, which is mounted with a snap fit in an annular groove 94 in the outer wall 88 of the holder 86.

The pump housing 14 comprises a cylindrical pump chamber 96, into whose upper open end a cylindrical inside sleeve 98 of the holder 86 engages in a coaxial manner, which is connected with the holder 86 at the upper end through an annular end wall 100.

The closing wall 100 has a circumferential groove 101 at its lower side above the outside flange 92, forming an air outlet slot between the pump housing 14 and the outside wall 88 of the holder 86, operating together with the bleeding channels in the holder 86 in a known manner.

A pump piston 102 can be moved back and forth in the pump chamber 96 and is provided with a hollow cylindrical piston shaft 104, which extends upward and protrudes beyond the closing cap 72 to the outside, out of the pump chamber 96 through the holder 86. The piston shaft 104 is adapted to a operating and dispensing button 106, which is provided with a dispensing opening 108, which is connected with the upper end of the piston shaft 104 via a radial outlet channel 110. An axial outlet channel 112 extends through the pump piston 102 and its shaft 104 upwards and connects the outlet channel 110 within the operating knob 106 with the pump chamber 96.

The outside of the piston shaft 104 is tapered towards the upper end, wherein the upper end of the pump piston 102 forms an upward and outward conically extending seal surface 114 for the upper end of the inner sleeve 98 of the holder 86 in order to seal it, when the pump piston 102 is located in the completely raised lifting position. However, when the pump piston 102 leaves the resting position, ambient air can penetrate into the container between the piston shaft 104 and the inner sleeve 98 in order to refill the volume of the dispensed content, and to maintain ambient pressure within the container.

Fluid is provided to the pump chamber 96 via the connection nipple 18 and the passage 20 through a fixed supply line, which is comprised of a tubular supply spout 116 in the shown preferred embodiment, which protrudes from the bottom 16 of the pump housing 14 into the pump chamber 96 and which has an open upper end.

A second differential piston is comprised from two parts, thus a valve body 118 and a seal sleeve 120 (FIG. 1). The valve body 118 is located axially above the supply spout 116, so that it can be moved together with the pump piston 102 and relative to it. The piston shaft 104 encloses an enlarged bore hole, whose upper end leads into the outlet channel 112 at a location, which is formed by an annular valve seat 122. The valve body 118 is provided with a valve cone 124 at its upper end, which abuts tight against the annular valve seat 122 in the pump piston 102, in order to prevent fluid from flowing out of the pump chamber 96 through the outlet channel 112.

A valve head 126 of the valve body 118 has an upper piston surface from which four ribs 128 protrude, which extend outward at identical circumferential angles. This piston surface of the valve head 126 is put under the pressure of the fluid in the pump chamber 96, as subsequently described in detail.

The lower side of the valve head 126 is provided with an annular groove 130 with trapezoid cross section and forms an integral part of an inlet valve 127. For this purpose, the outer lateral wall of the annular groove forms the valve surface 132, which is conically expanded downward and outward for sealing the upper conical contact surface of the seal sleeve 120, which is connected to the valve head 126, so that it is axially adjustable within limits. The valve surface 132 and the conical contact surface 134 form an acutely angled annular slot in downward direction with the central longitudinal axis X-X of the pump 70, when they are axially divided or offset. The inner side wall of the annular groove 130 is formed by a cylindrical guide pinion 136.

The seal sleeve 120 is provided with a substantially cylindrical piston jacket 138 on its side facing towards the container. The upper end of the seal sleeve 120 has an interior annular flange 140, whose lower side forms a shoulder, which rests on the upper end of a helical compression spring 142. In this non operated position, the inlet valve 127 is open between the contact surface 134 and the valve head 126. The ring flange 140 can be adjusted axially from this inactive position into a working position, in which the inlet valve 127 is closed.

According to FIG. 1, the helical compression spring 142 is supported with its lower end on the floor 16 within the pump chamber 96. It is apparent, that the helical compression spring 142 normally preloads the valve body 118 together with the abutting pump piston 102 into a completely raised position, when the pump 70 is in its non operated resting position.

When the lower free end of the seal sleeve 120 meets the tubular supply spout 116, the motion of the seal sleeve 120 is interrupted for a short period of time. However, the upper end of the seal sleeve 120 is quickly reached by the valve head 126, so that both parts assume the closed position. From this moment, the valve head 126 carries the seal sleeve 120 downward with it, so that the seal sleeve 120 slides over the supply spout 116 in a telescoping sealing manner. The friction resulting there from contributes to a relative pressure of the annular flange 140 onto the annular groove 130, so that the annular slot between the contact surface 134 and the seal sleeve 120 and the valve surface 132 of the valve head 126 is closed or sealed. From this moment, which starts immediately after the pump operation, the pump chamber 96 is closed completely, so that the depression of the pump piston 102 now causes an increase in pressure in the pump chamber 96.

As soon as the pump 70 is released, the helical compression spring 142 presses the valve body 118 back. The valve body 118 moves away from the seal sleeve 120, which is held in place due to the friction on the supply spout 116. Consequently, the annular groove between the valve head 126 and the annular flange 140 of the seal sleeve 120 opens, so that a connection between the container and the pump chamber 96 is established. The helical compression spring 142, on which the interior shoulder of the annular flange 140 rests, now engages the valve body 118 at the same time as the seal sleeve 120. This leads to a volume increase in the pump chamber 96. Since the inlet valve 127 is open, the fluid is let into the pump chamber 96. When the dosage pump 70 has completely returned into its initial or resting position, and the connection between the free lower end of the seal sleeve 120 and the upper end of the supply spout 116 is established again, no more fluid is sucked through the supply spout 116.

Upon the first operation of the pump 70, air is pressed out of the pump while product is sucked in on the backstroke. In the approximately vertical position of the pump 70 with the adapter 12 in FIGS. 1 and 2, the product is sucked through the riser tube 22 during the backstroke. The product flows around the stop valve 32 and fills the pump chamber 96. Hereby, the inlet valve 30 formed by the valve disk 31 remains closed. During the pump stroke, some of the product, which is not located in the pump chamber 96, is pressed downward through the adapter 12 past the stop valve 32 through the riser tube 22, because the stop valve 32 is being held in its throttle position.

In the inverted position of the pump 70 with the adapter 12 shown in FIG. 3, the stop valve 32 drops onto its throttle- or ball seat 36 and seals it during the backstroke. Through this seal a vacuum in the pump chamber 96 is generated, through which the valve disk 31 is bent upwards with its outer rim, thereby it comes clear of the fluid tight collar 60 and consequently opens the inlets 28. Thereby, the product is sucked into the pump 70 through the inlets 28 in the adapter 12 and past the valve disk 31. At the end of the filling process, the outer rim of the valve disk 31 descends again onto the fluid tight collar 60 into the closed position of the inlets 28, so that the product can be dispensed out of the pump chamber 96 in a customary manner.

### REFERENCE NUMERALS

10 Dispenser
12 Adapter
14 Pump housing
15 Screw cap
16 Housing floor
18 Connection nipple
20 Passage
22 Riser tube
24 Adapter housing
26 Connection channel
28 Inlets
30 Inlet valve
31 Valve disk
32 Stop valve
34 Stop valve chamber
36 Stop valve seat
38 Support device
40 Throttle opening
42 Bypass flow channel
44 Upper piece
46 Lower piece
48, 50 Floors
51 Annular chamber
52 Tubular spout
54 Connection channel
56 Lateral bore holes
58 Annular groove
59 Lower side (annular groove)
60 Fluid tight collar
62 Upper longitudinal section
64 Axial opening
66 Lower longitudinal section
70 Dosage pump
72 Closing cap
74 Thread
76 Upper sleeve shaped end (upper piece 44)
77 Stop surface
78 Riser tube nipple
80 Cylindrical hollow wall
82 Cylindrical opening
84 Inside flange
86 Holder
88 Outside wall
90 Outside flange
92 Upper flange
94 Annular groove
96 Pump chamber
98 Cylindrical interior sleeve (holder 86)
100 End wall
101 Circumferential groove
102 Pump piston
104 Hollow cylindrical piston shaft
106 Operating and dispensing knob
108 Dispensing opening
110 Radial outlet channel
112 Axial outlet channel
114 Seal surface
116 Feed spout
118 Valve body
120 Seal sleeve
122 Annular valve seat
124 Valve cone
126 Valve head
127 Inlet valve
128 Ribs
130 Annular groove
132 Valve surface
134 Conical contact surface
136 Cylindrical guide pinion
138 Piston jacket
140 Annular flange
142 Helical compression spring

1. A manually operated dispenser (10) with an adapter (12) for a pressurized or pressurizeable fluid in a container in its substantially upright position and in its substantially inverted or overhead position, comprising:
a) a pump housing (14), which can be mounted on an opening at the upper end of the container in a sealing manner;
b) a floor (16), at whose lower end a connection nipple (18) is disposed;
c) a passage (20), which extends through the floor (16) and the connection nipple (18), and which is connected to a riser tube (22) extending into the fluid in the container for passing the fluid in the substantially upright position of the container;
d) a tubular adapter housing (24), which includes a connection channel (54) between the riser tube (22) and the passage (20) of the housing (14) of the dispenser (10);
e) a plurality of inlets (28) in the adapter housing (14) for the fluid in the substantially inverted position of the container for the dispenser (10);
f) an inlet valve (30) within the adapter housing (24) for the approximately simultaneous closing of the inlets (28) in the substantially upright position of the container, but for the approximately simultaneous opening of the inlets (28) under a pressure acting upon the fluid in the container in the substantially inverted position of the container;
g) a stop valve (32), which is disposed within the valve chamber (34) of the adapter housing (24) between two end positions, so it can move freely in an axial manner, wherein in an upright position of the container the upper end position is defined through a stop valve seat (36) extending laterally through the adapter housing (24), and the lower position is defined through a support device (38), in which the stop valve (32) assumes a throttle position for the fluid, leaving a throttle opening (40);
h) a valve chamber (34) with a diameter, which is larger than the diameter of the stop valve (32) in order to form an overflow channel (42) for the fluid in an upright position of the container,
characterized in that,
the adapter housing (24) is comprised of an upper piece (44) and a lower piece (46), whose floors (48, 50) are disposed with axial spacing from each other, and form an annular chamber (51), through which a tubular spout (52) reaches, which includes a connection channel (54), which establishes a liquid connection between the stop valve chamber (34) and a pump chamber (96) in the pump housing (14), and the tubular spout (52) is connected with the annular chamber (51) via lateral bore holes (56) in an annular groove (58), and that the floor (50) of the bottom part (46) of the adapter housing (24) has the inlets (28) for the fluid in the inverted position of the adapter (12), as well as a fluid tight collar (60) within the annular chamber (51), which radially protrudes outside of the inlets (28), and that the inlet valve (30) is an annular disk (31), which is elastic with respect to bending, which encloses the annular groove (58) in a tight manner and which rests on the fluid tight collar (60) with its outer rim, sealing the inlets (28), but rises from the fluid tight collar (60) in the inverted position of the adapter (12) under the suction of the pump for opening the inlets (28).

2. Dispenser according to claim 1,
characterized in that,
the upper piece (44) of the adapter housing (24) can be placed onto the lower end of the pump housing (14) and its riser tube nipple (18) in a friction locked manner, wherein the tubular spout (52) has an upper longitudinal section (68), which rises from the floor (48) of the upper piece (44), and which can be inserted into an opening (64) of the riser tube nipple (18) of the pump housing (14).

3. Dispenser according to claim 1,
characterized in that,
a lower longitudinal section (66) of the tubular spout (52) extends from the lower side of the floor (48) of the upper piece (44) of the adapter housing (24) through the annular chamber (51) and the annular floor (50) of the lower piece (46) into the upper end of the stop valve chamber (34) forming the valve seat (36) for the stop valve (32) at its lower front end in the inverted position of the dispenser (10).
